(19) United States
(12) Patent Application Publication
(10) Pub. No.: US 2017/0036347 A1
(43) Pub. Date: Feb. 9, 2017

(54) Device And Method For Secure Control Of A Manipulator

(71) Applicant: KUKA Roboter GmbH, Augsburg (DE)

(72) Inventors: Uwe Bonin, Friedberg (DE); Stefan Sturm, Sulzdorf (DE)

(21) Appl. No.: 15/299,599

(22) Filed: Oct. 21, 2016

Related U.S. Application Data
(63) Continuation of application No. 12/868,184, filed on Aug. 25, 2010, now abandoned.

(30) Foreign Application Priority Data
Aug. 25, 2009 (DE) 10 2009 038 721.8

(51) Int. Cl. B25J 9/16; B25J 19/06; F16P 3/08

(52) U.S. Cl. CPC B25J 9/1676; F16P 3/08; B25J 19/06; G05B 2219/39082; G05B 2219/39088; G05B 2219/40203

(57) ABSTRACT

A method for controlling a robotic manipulator includes manually controlling the robotic manipulator with an operating device connected to a control device of the manipulator and having a first safety level, and monitoring an admissible state of operation with a protective device connected to the control device and having a second, higher safety level, The manipulator performs an operation commanded by the operating device only if the protective device is communicating an admissible state to the control device.

### CROSS-REFERENCE TO RELATED APPLICATIONS

This application is a continuation of U.S. patent application Ser. No. 12/868,184 filed Aug. 25, 2010 (pending), which claims the benefit of priority to German Application No. DE 10 2009 038 721.8 filed Aug. 25, 2009 (pending), the disclosures of which are incorporated by reference herein in their entirety.

### TECHNICAL FIELD

The present invention relates to a method and an arrangement for safe manual control of a manipulator, in particular a robot such as for example an industrial robot.

### BACKGROUND

Because of the potential for endangering operating personnel, industrial robots must be operated using reliable technology. For example, the relevant standard ISO 10218-1:2006 stipulates that a manual programming device must have a three-position enabling pushbutton. Such pushbuttons, which are known for example from DE 100 23 199 A1 and DE 299 23 980 U1, differentiate between a non-activated position, a panic position with fully-pressed pushbutton, and a middle position. The robot moves only when the middle position is detected using reliable technology and is reported to the controller of the robot.

Such reliable detection, evaluation and transmission of control commands, as described for example in DE 44 32 768 C2 and WO 99/29474 A2, is expensive because of the necessary redundancy or diversity, proven operational effectiveness and the like.

### SUMMARY

The object of the present invention is to improve the safe control of a manipulator.

The invention is based on the idea of separating the safety and control functionalities. This makes it possible on the one hand to employ an operating device of a lower safety level to control the manipulator manually, since said device only needs to realize the control functionality, and thus can be of simpler, more economical, more mobile and/or more compact design. On the other hand, to guarantee the safety functionality a protective device of a higher safely level can be used, which is already available anyway for automatic operation of the manipulator. For example, if a protective device such as a protective fence with monitored protective door, preferably provided for automatic operation of the manipulator, ensures that there is no operator within a forbidden protected zone, according to the invention the manipulator can also be controlled using non-secure technology by means of an operating device of a low safety level.

Correspondingly, according to the invention the manipulator is controlled by means of an operating device of a first safety level, which is connected to a control device of the manipulator.

In this case the operating device can be for example a stationary or mobile personal computer (“PC”) or a hand-held device such as for example a so-called personal digital assistant (“PDA”), a mobile telephone or the like, and because of the low safety requirement can be designed with non-secure technology.

The operating device can be hard-wired to the control device, in particular via a network, or may be connected wirelessly, preferably using electromagnetic radiation such as radio or optical or infrared signals.

Controlling refers in particular to inputting target positions and/or target position changes, for example for axes of the manipulator or position and/or orientation of a reference point or coordinate system fixed in relation to the manipulator, such as the TCP (tool center point), tool movements and/or activations and the like, where in the preferred online teaching the manipulator executes control commands directly and/or they are stored. In this respect, controlling means in particular direct movement of the robot using corresponding control commands. Control commands can be entered for example via keys, a joystick, a mouse and/or a touch screen of the operating device.

The control software, for example a path interpolator, can be implemented in the operating and/or control device, so that in a preferred embodiment the operating device is used only for inputting and transmitting control commands. The operating device can also have a display, for example for displaying inputs and/or visualizing input parameters and/or other parameters.

According to the invention, a protective device of a second, higher safety level, which is connected to the control device of the manipulator, monitors a permissible state. A permissible state can exist in particular when there is no person within a forbidden protected zone. Then no personal injury can occur even if there is a malfunction of the non-secure operating device.

This can be guaranteed for example by a protective fence with one or more monitored safety doors surrounding the forbidden protected zone. Similarly, the protected zone can also be monitored, for example optically, so that entry or presence of persons therein can be detected. In these cases the protective device does not communicate a permissible state to the control device if an operator is within the forbidden protected zone.

The protective device can likewise remove a release signal which indicates a permissible state and/or transmit a disturbance signal which indicates a non-permissible state, in order to not communicate a permissible state to the control device. This too can be done via a hard-wired connection, in particular over a network, or by wireless transmission, as explained above.

In addition or as an alternative to monitoring whether there is a person in a non-permissible protected zone, the manipulator itself can also be monitored, for example by reliably detecting its joint positions and/or positions of one or more of its components or reference points or coordinate systems fixed in relation to the manipulator, and comparing them to permissible value ranges.

A safety level can correspond for example to a safety category according to a relevant standard. At the same time, a higher safety level, in particular the second safety level, can correspond to a reliable technology, and sufficient established operational effectiveness, failure safety and the like can be guaranteed for example by means of appropriate redundancy or diversity, for example through multi-channel protective devices and secure data transmission to and data interpretation in the control device. Correspondingly, a lower safety level, in particular the first safety level, can be implemented using non-secure standard technology. Even technologies that do not satisfy any safety requirements can fulfill a low or first safety level in the meaning of the present invention, where in a preferred embodiment even the first safety level fulfills certain (minimum) safety requirements, which are however preferably lower than those of the reliable technology.

As explained above, the invention is based on the realization that the increased safety demands that have been placed heretofore on operating device for controlling manipulators can be dispensed with if safety is guaranteed by a separate protective device, preferably one that is present anyway for example for automatic operation, if said device ensures that the operator of the operating device remains outside of the forbidden protected area.

Correspondingly, according to the invention the manipulator performs all or at least certain ones of the actions specified by the operating device only if the protective device communicates a permissible state to the control device. In particular, it can be sufficient to prevent motions of the manipulator and/or tool motions and/or activities when the protective device is not communicating a permissible state to the control device.

To this end the control device can for example switch off the operating device, ignore control commands of the operating device, or delay their execution until release is given by the protective device.

Similarly, all actions of the manipulator can also be suppressed as long as the protective device is not communicating a permissible state to the control device, or only motions in non-exceptional axes such as are executed, while dangerous axes, for example carousel, rocker and/or arm axes are deactivated. In addition or alternatively, in a preferred embodiment actions, in particular motions, are not suppressed until after the manipulator has been transformed into a secure state, when the protective device is no longer communicating a permissible state to the control device.

Preferably, as long as the protective device is not communicating a permissible state to the control device there is also a display on the operating device, in particular a display of the non-permissible state.

In particular, in order to utilize already existing protective devices such as a protective fence with protective door for the automatic operation of an industrial robot, the control device for controlling the manipulator can be placed by means of the operating device in a particular operating mode, in which for example motions of the manipulator are only executed as long as the protective device is active, i.e., is communicating a permissible state or is not communicating a non-permissible state. The changeover to this operating mode can be accomplished for example by activating the control device, the operating device, by connecting the control and operating devices, manually or when inputting a control command into the operating device.

In this case in particular, the manipulator can also be controlled by means of a selected one of a plurality of operating devices. Preferably there is then assurance through reciprocal communication among the operating devices, dominant signal transmission, or by the control device, that always only one operating device is active or enables the inputting of control commands to the control device.

In order to also offer the operator who is safely controlling the manipulator according to the invention through a non-secure operating device the possibility to react to problems not recognized by the protective device, in a preferred embodiment an emergency stop input device of a higher safety level, in particular one using reliable technology, is connected to the control device of the manipulator, it being preferred to situate said emergency stop input device in the vicinity of the non-secure operating device, in particular within reach of the operator of the operating device. Such an emergency stop input device can be situated for example as a standardized emergency off switch simply, compactly and conveniently on or near a PC, PDA or the like.

The operating device of the first safety level, like previously employed operating devices using reliable technology, can have an enabling device. The latter can include in particular a pushbutton or a key combination of a keyboard of the operating device. Since it is not used for protecting persons, this enabling device, in contrast to the existing art, advantageously is not subject to any increased safety requirements.

In addition to or alternatively to one or more additional operating devices of a lower, in particular a first safety level, one or more additional operating devices of a higher, in particular a second safety level may be provided. In particular to control the manipulator when the protective device is deactivated, for example when there is an operator within the protected zone, a manual programming device or the like using secure technology can be used. The control system executes the actions specified by this secure operating device even if the protective device is not communicating a permissible state to the control device, for example by selecting an appropriate operating mode of the control device and deactivating or ignoring the non-secure operating device.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

Additional advantages and features result from the subordinate claims and the exemplary embodiments. To this end the sole figure shows the following, partially in schematic form.

FIG. 1: a control system for a robot according to an embodiment of the present invention.

### DETAILED DESCRIPTION

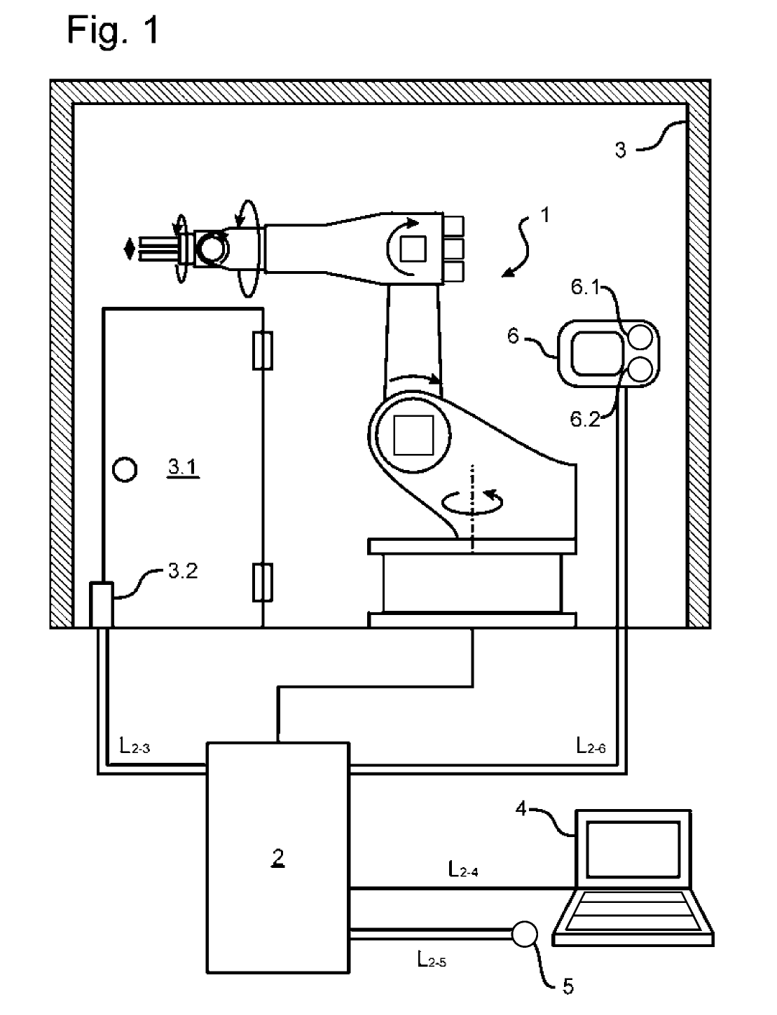

FIG. 1 shows in cross section a six-axis industrial robot 1 having a control cabinet 2. Robot 1 is only allowed to move within a working area bounded by a protective fence 3 in which no persons are allowed to be present during automatic operation, and which thus defines a prohibited protected zone.

To this end it has a protective door 3.1, which is monitored through a closing contact 3.2. To guarantee safety of personnel, the protective device with protective fence 3, protective door 3.1 and closing contact 3.2 uses secure technology. In particular, closing contact 3.2 is connected to control cabinet 2 using secure technology through the multi-channel redundant conductor L₂₋₃ indicated in FIG. 1, and accordingly has a second, high safety level, for example category 3.

For controlling robot 1, in particular for inputting travel commands in joint or world coordinates, a standard PC 4 is provided. The latter is connected via a simple network, indicated in FIG. 1 in single-channel form by conductor L₂₋₄, to control cabinet 2, which interprets and processes the control commands entered via the keyboard of PC 4 and actuates the drives of robot 1 accordingly. The input data are visualized on the screen of PC4, for example by depicting the robot in the virtual working space and/or its joint angles. The standard PC 4, connected by a single channel to control cabinet 2, is thus an operating device using non-secure technology, of a first, low safety level, for example category 1 or lower.

In order to ensure safety of personnel from problems not detected by the protective device, within reach next to the PC 4 a standard emergency off switch 5 (indicated in multi-channel form in FIG. 1 by conductor L₂₋₄) is connected to control cabinet 2, and thus forms an emergency off input device of an equally high or higher safety level than protective device 3-3.2.

In order to be able to also control the robot reliably within the protected zone, a conventional manual programming device 6 with an emergency off switch 6.1 and an enabling pushbutton 6.2 can be connected in addition through multi-channel conductor L₂₋₆ to control cabinet 2 using secure technology.

Control over the manipulator can be turned over either to the PC 4 or to the manual programming device 6, if present, by a user action. If control is turned over to the manual programming device 6, the control system 2 of the robot ignores inputs from the PC 4.

Conversely, in an operating mode for controlling the manipulator by means of operating device 4, in which control device 2 is placed by switching the control system over, the control system executes only motions specified by the PC 4 as long as closing contact 3.2 reports a closed protective door 3.1 or does not report an open protective door 3.1 to control device 2, thereby guaranteeing that no person is entering the protected zone defined by protective fence 3. If other problems arise, for example intrusion into the protected zone through a hole in protective fence 3, the operator can shut down the robot reliably by operating the emergency off button 5 situated in quickly accessible proximity.

Thus the robot can be controlled inexpensively and yet reliably through a standard PC 4, which uses non-secure technology and is connected to control cabinet 2, as a result of using the protective device 3, 3.1, 3.2 provided for automatic operation.

While the present invention has been illustrated by a description of various embodiments, and while these embodiments have been described in considerable detail, it is not intended to restrict or in any way limit the scope of the appended claims to such detail. The various features shown and discussed herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### REFERENCE LABELS

1 robot

2 control cabinet

3 protective fence

3.1 protective door

3.2 closing contact

4 standard PC (operating device)

5 emergency off switch

6 manual programming device

6.1 emergency off switch

6.2 enabling pushbutton

L₂₋ₓ conductor (one- or two-channel)

What is claimed is:

1. A method for safe control of a robotic manipulator, comprising:
manually controlling the robotic manipulator with an operating device connected to a control apparatus of the robotic manipulator;
monitoring an admissible state of operation of the robotic manipulator with a protective device connected to the control apparatus;
wherein the operating device has a first, low safety level and an enabling device that does not serve for personal protection and is not subject to increased safety requirements;
wherein the protective device has a second safety level that is higher than the first safety level; and
transferring the control apparatus to a defined operation mode in which the manipulator only performs an operation commanded by the operating device if the protective device transmits an admissible state to the control apparatus;
wherein the control apparatus is transferred to the defined operation mode by at least one of:
activating the operating device,
manually connecting the control apparatus and the operating device, or
entering a control command into the operating device;
wherein the protective device does not transmit an admissible state to the control apparatus if a user is within an inadmissible protection area.

2. The method of claim 1, wherein the operation commanded by the operating device comprises a motion of the robotic manipulator.

3. The method of claim 1, wherein manually controlling the robotic manipulator with an operating device comprises controlling the robotic manipulator with a selected one of a plurality of operating devices.

4. An arrangement for controlling a robotic manipulator, comprising:
a control apparatus configured to control movement of the robotic manipulator;
an operating device having a first, low safety level and configured to facilitate manual control of the robotic manipulator by a user, the operating device connected to the control apparatus and including an enabling device; and
a protective device connected to the control apparatus and having a second safety level that is higher than the first safety level, the protective device monitoring an admissible state of operation of the robotic manipulator;
wherein the control apparatus is transferred to a defined operation mode in which the manipulator only performs an operation commanded by the operating device if the protective device transmits an admissible state to the control apparatus;
wherein the control apparatus is transferred to the defined operation mode by at least one of:
activation of the operating device,
manual connection of the control apparatus and the operating device, or
entry of a control command into the operating device; and
wherein the protective device does not transmit an admissible state to the control apparatus if the user is within an inadmissible protection area.

5. The arrangement of claim 4, further comprising an emergency stop operating device having a second safety level that is higher than the first safety level and which is connected to the control apparatus of the robotic manipulator.

6. The arrangement of dam 4, further comprising at least one additional operating device having a first, low safety level.

7. The arrangement of claim 4, further comprising at least one additional operating device having a second safety level that is higher than the first safety level. The arrangement of dam 4, wherein the protective device includes at least one of a safety fence, a safety door, a closing contact, or an area monitoring device.

9. The arrangement of claim 8, wherein the area monitoring device comprises an optical device.

10. A computer program stored on a non-transitory, computer-readable storage medium, the computer program, when run by a control apparatus of a robotic manipulator, causing the control apparatus to:
facilitate manual control of a robotic manipulator with an operating device connected to the control apparatus;
monitor an admissible state of operation of the robotic manipulator with a protective device connected to the control apparatus;
the operating device having a first, low safety level and an enabling device that does not serve for personal protection and is not subject to increased safety requirements;
the protective device having a second safety level that is higher than the first safety level; and
transfer the control apparatus to a defined operation mode in which the manipulator only performs an operation commanded by the operating device if the protective device transmits an admissible state to the control apparatus;
wherein the control apparatus is transferred to the defined operation mode in response to at least one of:
activation of the operating device,
manual connection of the control apparatus and the operating device, or
entry of a control command into the operating device;
wherein the protective device does not transmit an admissible state to the control apparatus if a user is within an inadmissible protection area.

11. A computer program product with programming code stored on a non-transitory, computer-readable storage medium and comprises a computer program according to claim 10.
